(19) United States
(12) Patent Application Publication
(10) Pub. No.: US 2022/0287248 A1
(43) Pub. Date: Sep. 15, 2022

(54) METHOD OF OPERATING AN INDOOR GARDENING CENTER FEATURING PROGRAMMABLE ROTATION

(71) Applicant: Haier US Appliance Solutions, Inc., Wilmington, DE (US)

(72) Inventors: Louis A. Wantland, Louisville, KY (US); Tatiana Ferrucio Ferreira, Rochester, NY (US); Matthew R. Hunter, Louisville, KY (US); Lauren Nicole Platts, Louisville, KY (US); Brian Michael Schork, Louisville, KY (US)

(21) Appl. No.: 17/197,669

(22) Filed: Mar. 10, 2021

(51) Int. Cl. A01G 9/02; A01G 7/04; G05B 19/042

(52) U.S. Cl. CPC A01G 9/023; A01G 7/045; G05B 19/042; G05B 2219/25252

(57) ABSTRACT

A method of operating a gardening appliance includes determining one or more isolation sections from a plurality of support sections, determining a lock schedule for isolating the one or more isolation sections, the lock pattern being different from a normal rotation pattern, and operating a motor to rotate a grow module in accordance with the lock pattern such that the one or more isolation sections are obscured from view.

### FIELD OF THE INVENTION

The present subject matter relates generally to systems for gardening plants indoors, and more particularly to systems and methods for implementing a rotation cycle for improving a growing profile of a selected plant.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow. Additionally or alternatively, certain garden centers may include separate grow chambers within the cabinet to create individual growth atmospheres for different types of plants.

Notably, certain plants may require specific attributes in order to grow most efficiently. For example, specific light cycles may be required to control blooming. Additionally or alternatively, precise temperature and humidity control may be required to produce best effects and reduce certain drawbacks. However, conventional indoor gardening centers are not capable of effectively controlling such attributes. In particular, rotating indoor garden centers typically allow ambient light into multiple chambers. Further, independent regulation of chamber temperature and humidity may be difficult.

Accordingly, an improved indoor garden center would be useful. More particularly, an indoor garden center with a programmable schedule of rotation and a method of operating an indoor gardening center would be particularly beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a gardening appliance is provided. The gardening appliance may include a cabinet including a display opening, a grow module rotatably mounted within the cabinet and defining a plurality of support sections, and a motor configured to rotate the grow module. The method may include determining one or more isolation sections of the plurality of support sections; determining a lock schedule for isolating the one or more isolation sections among the plurality of support sections; and operating the motor to rotate the grow module in accordance with the lock schedule such that the one or more isolation sections are obscured from view through the display opening.

In another exemplary aspect of the present disclosure, a gardening appliance is disclosed. The gardening appliance may include a liner positioned within a cabinet and defining a grow chamber; a display opening provided in the cabinet; a grow module rotatably mounted within the liner, the grow module defining a plurality of support sections; a motor provided within the cabinet and configured to rotate the grow module; and a controller operably coupled to the motor and configured to perform a series of operations. The series of operations may include determining one or more isolation sections of the plurality of support sections; determining a lock schedule for isolating the one or more isolation sections among the plurality of support sections; and operating the motor to rotate the grow module in accordance with the lock schedule such that the one or more isolation sections are obscured from view through the display opening.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a schematic illustration of an exemplary gardening appliance in communication with a remote user interface device according to one or more embodiments of the present subject matter.

FIG. 10 is a flow chart illustrating a method of operating a gardening appliance in accordance with the present subject matter.

FIG. 11 is a schematic diagram illustrating a method of operating a gardening appliance in accordance with the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

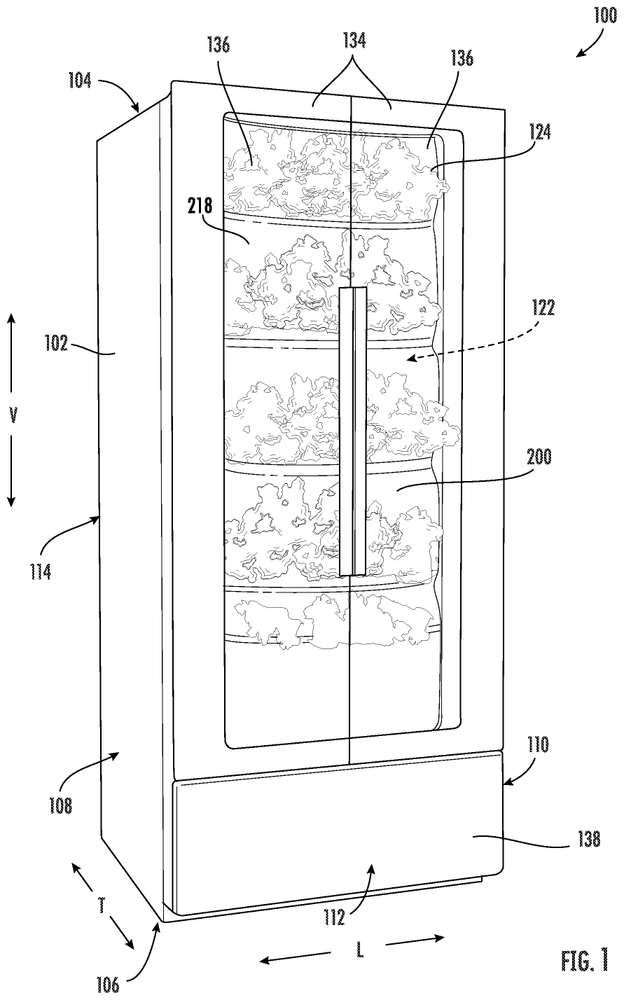

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled chamber, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

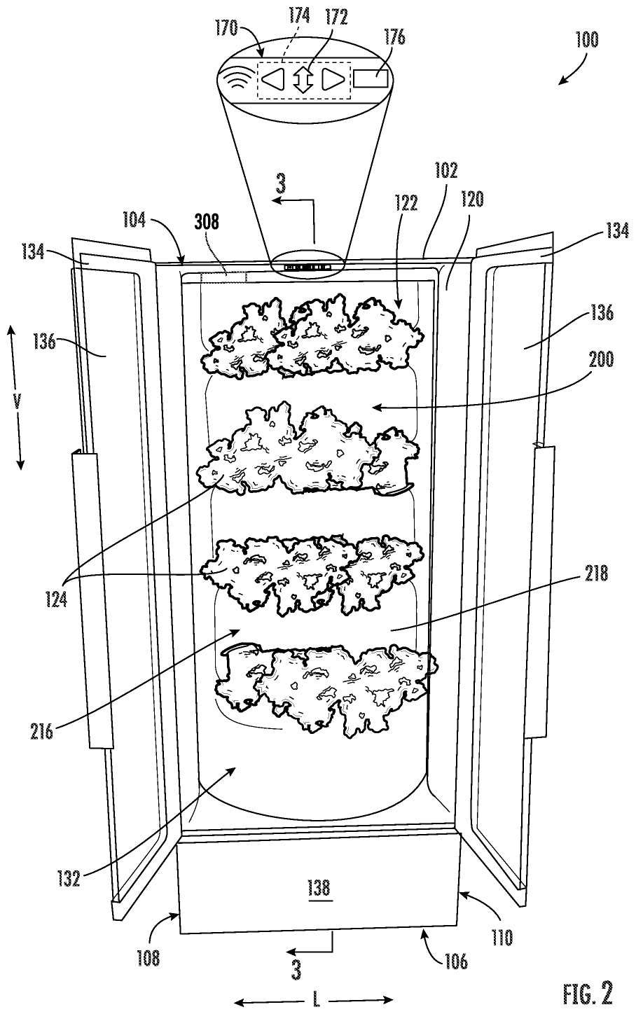

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the opened position for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

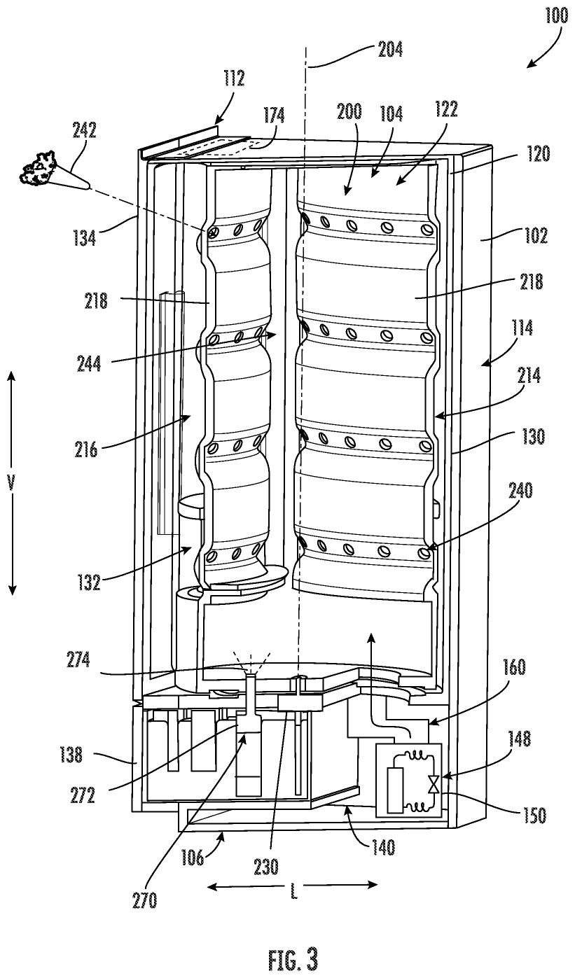

FIG. 3 provides a schematic view of certain components of an environmental control system 148 that may be used to regulate a temperature within grow chamber 122. Specifically, environmental control system 148 may include a sealed system 150, a duct system 160, and a hydration system 270, a lighting system 300, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

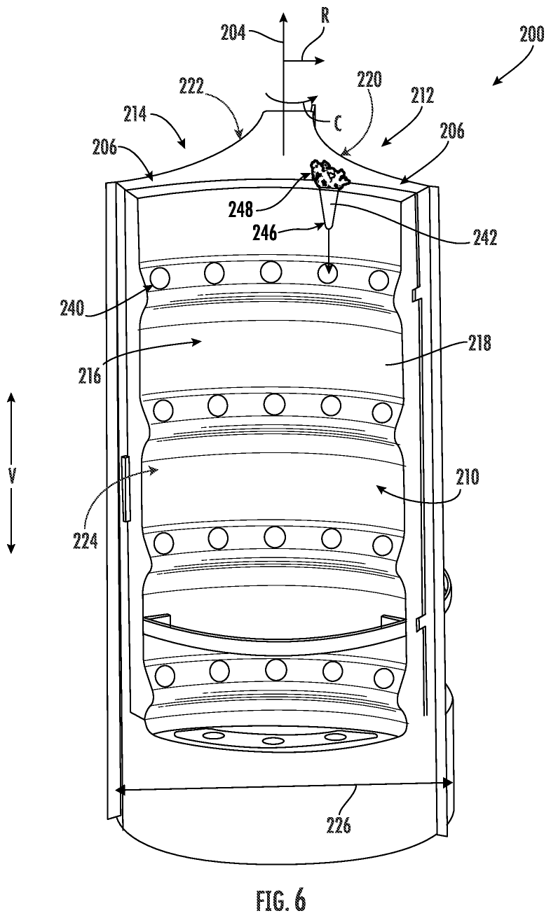

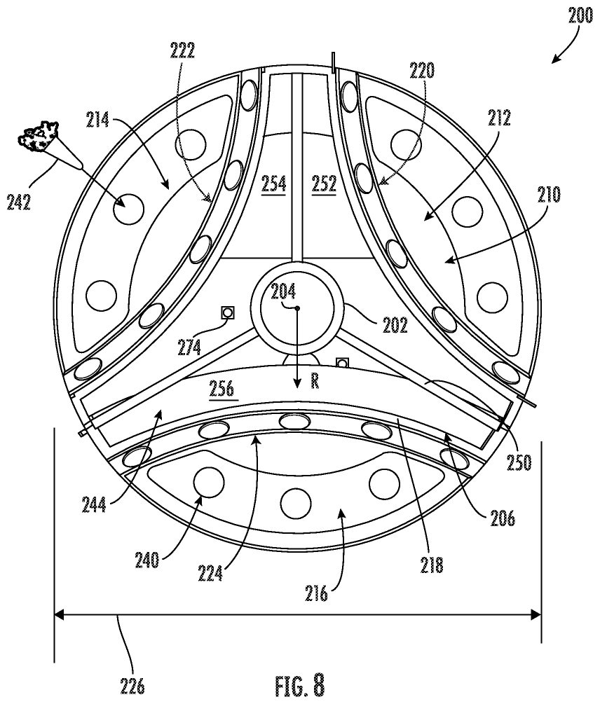

Referring now generally to FIGS. 1 through 8, gardening appliance 100 generally includes a rotatable carousel, referred to herein as a grow module 200 that is mounted within liner 120, e.g., such that it is rotatable within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

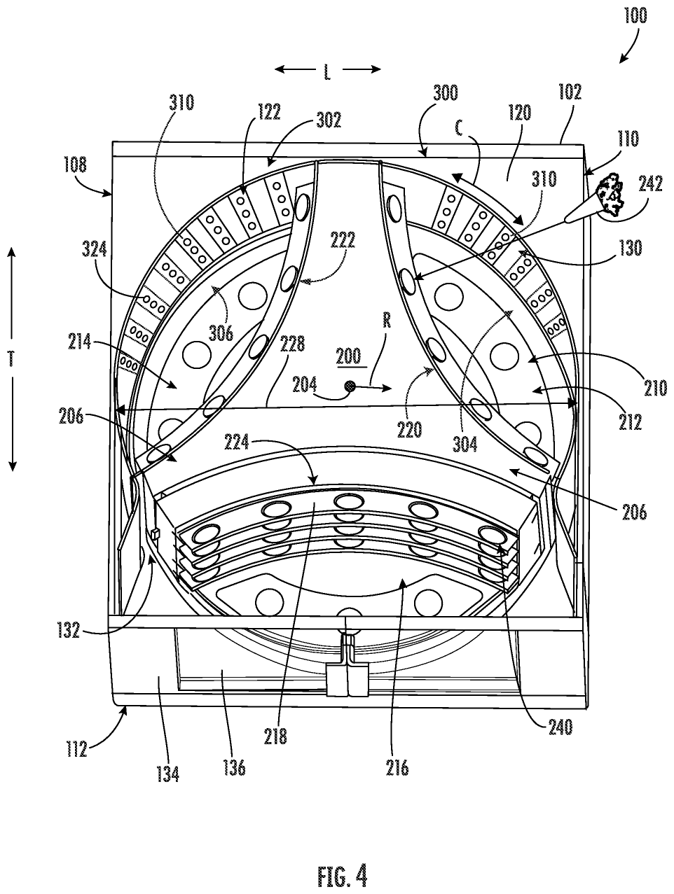

Grow module 200 may further include a plurality of partitions 206 that extend from central hub 202 substantially along the radial direction R. In this manner, grow module 200 divides or partitions grow chamber 122 into a plurality of sub-compartments or sub-chambers, referred to herein generally by reference numeral 210, when it is in its zero position as illustrated. Referring specifically to a first embodiment of grow module 200 illustrated in FIGS. 1 through 8, grow module 200 includes three partitions 206 to divide grow chamber 122 into a first grow chamber 212, a second grow chamber 214, and a third grow chamber 216, which are circumferentially spaced relative to each other. For example, each grow chambers 212-216 may each span approximately 120° about the circumferential direction C. In general, as grow module 200 is rotated within grow chamber 122, the plurality of chambers 212-216 refer to the fixed regions within grow chamber 122 that define substantially separate and distinct growing environments, e.g., for growing plants 124 having different growth needs. While the plurality of grow chambers 212-216 may rotate as grow module 200 rotates, the relative positions within liner 120 may remain constant. For instance, with reference to FIG. 4, first grow chamber 212 may be in a first sealed position, second grow chamber 214 may be in a second sealed position, and third grow chamber 216 may be in a display position. The positions may remain constant as the plurality of grow chambers 212-216 rotate, such that each of the plurality of grow chambers 212-216 rotates through each of the first and second sealed positions and the display position according to a normal rotating schedule.

As shown, grow module 200 defines three different plant support sections, referred to herein as first support section 220, second support section 222, and third support section 224. Notably, as grow module 200 is rotated within liner 120, support sections 220-224 are sequentially positioned or cycled through each respective grow chamber 212-216. In this manner, the environment within each grow chamber 212-216 may be independently regulated in a manner suitable to plants supported within support section 220-224 that is currently positioned therein. More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition are joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 226 (e.g., defined by its substantially circular footprint formed in a horizontal plane). Similarly, enclosed back portion 130 of liner 120 may be substantially cylindrical and may define a liner diameter 228. In order to prevent a significant amount of air from escaping between partitions 206 and liner 120, liner diameter 228 may be substantially equal to or slightly larger than grow module diameter 226. Grow module 200 may further include one or more resilient sealing elements, such as a wiper seal, to engage liner 120 and form environmental seals for first grow chamber 212 and second grow chamber 214.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles (which will be described in further detail below), based on user inputs (e.g. via touch buttons 172), etc. In addition, controller 174 may be communicatively coupled to one or more sensors, such as temperature or humidity sensors, positioned within the various sub-chambers 210 for measuring temperatures and/or humidity, respectively. Controller 174 may then operate environmental control system 148 to maintain desired environmental conditions for each of the respective sub-chambers 210 and may selectively position support sections 220-224 in the desired sub-chambers 210 to facilitate optimal plant growth. For example, gardening appliance 100 may include features for providing certain locations of gardening appliance 100 with light, temperature control, proper moisture, nutrients, and other requirements for suitable plant growth. Motor 230 may be used to position specific support sections 220-224 where needed to receive such growth requirements.

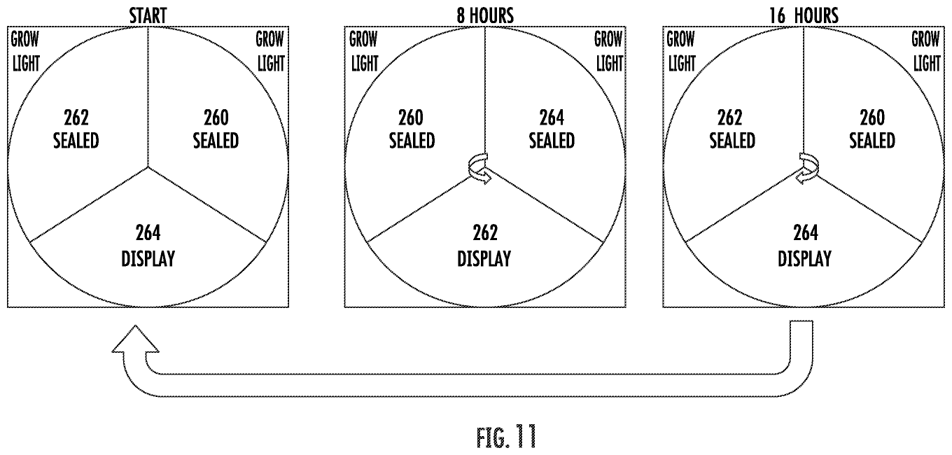

According to an exemplary embodiment, such as where three partitions 206 form three grow chambers 212-216, controller 174 may operate motor 230 to index grow module 200 sequentially through a number of preselected positions. More specifically, motor 230 may rotate grow module 200 in a counterclockwise (or clockwise) direction (e.g. when viewed from a top of grow module 200) in 120° increments to move support sections 220-224 between sealed positions and display positions. As used herein, a support section 220-224 is considered to be in a “sealed position” when that support section 220-224 is substantially sealed between grow module 200 (i.e., central hub 202 and adjacent partitions 206) and liner 120. In other words, support sections 220-224 are in a sealed position when positioned in the first grow chamber 212 or second grow chamber 214. By contrast, a support section 220-224 is considered to be in a “display position” when that support section 220-224 is at least partially exposed to front display opening 132, such that a user may access plants 124 positioned within that support section 220-224. In other words, support sections 220-224 are in a display position when positioned in the third grow chamber 216. Accordingly, each support section 220-224 may define a corresponding section chamber that rotates as grow module 200 rotates. In other words, while grow chambers 212-216 delineate fixed positions within grow module 200, section chambers defined by individual support sections 220-224 may rotate as grow module 200 rotates. Thus, as best shown in FIG. 11, a first section chamber 260, a second section chamber 262, and a third section chamber 264 may respectively switch positions as grow module 200 rotates.

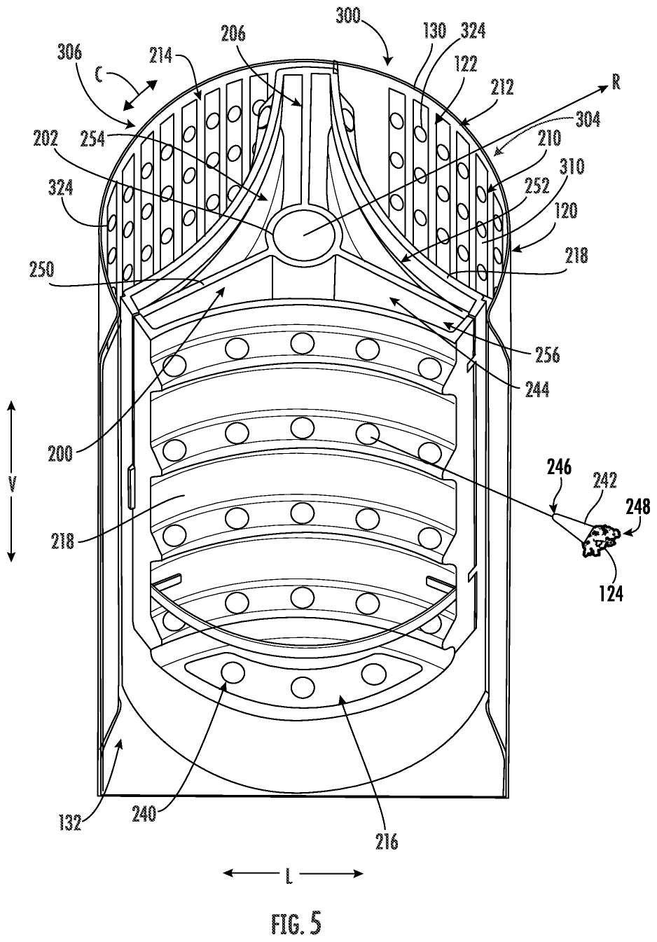

For example, as illustrated in FIGS. 4 and 5, first support section 220 and second support section 222 are both in a sealed position, whereas third support section 224 is in a display position. As motor 230 rotates grow module 200 by 120 degrees in the counterclockwise direction, second support section 222 will enter the display position, while first support section 220 and third support section 224 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow sub-chambers 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

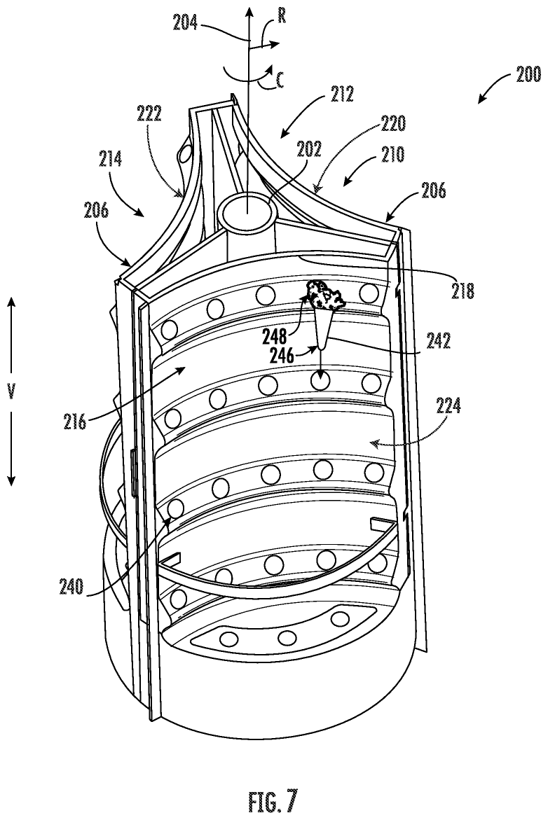

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow sub-chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first support section 220, second root chamber 254 may provide water and nutrients to plants 124 positioned in the second support section 222, and third root chamber 256 may provide water and nutrients to plants 124 positioned in the third support section 224. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. According to exemplary embodiments, hydration system 270 may include one or more pumps for providing a flow of liquid nutrients to misting device 274. In this regard, for example, water or nutrients that are not absorbed by roots of plants 124 may fall under the force of gravity into a sump. The pump may be fluidly coupled to the sump to recirculate the water through misting device 274.

Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature, humidity (e.g., or some other suitable water level quantity or measurement), and other grow parameters within one or all of the plurality of chambers 210 and/or root chambers 252-256 independently of each other. In this manner, a versatile and desirable growing environment may be obtained for each and every chamber 210.

Referring now specifically to FIGS. 4 and 5, gardening appliance 100 may further include a lighting system 300 which is generally configured for providing light into grow chamber 122 to facilitate photosynthesis and growth of plants 124. Specifically, lighting system 300 may include numerous lighting assemblies (identified generally by reference numeral 302) that may generate light having different wavelengths, intensities, colors, etc. Moreover, each lighting assembly 302 may be independently operated, e.g., by controller 174 of gardening appliance 100, in order to provide optimal lighting needs for each plant located within each of the plurality of grow chambers 212-216.

Notably, the lighting assemblies 302 positioned within each grow chamber 212-216 may be different and independently operated for more versatility in the grow lighting or other lighting directed toward plants 124. In this regard, the lighting assembly 302 in first grow chamber 212 may be referred to herein as first lighting assembly 304, while the lighting assembly 302 in second grow chamber 214 may be referred to herein as the second lighting assembly 306. Exemplary configurations of lighting assemblies 304 and 306 will be described below according to exemplary embodiments of the present subject matter. However, it should be appreciated that the specific lighting configurations shown are only intended to explain aspects of the present subject matter. Thus, variations and modifications may be made to lighting assemblies 304, 306 while remaining within the scope of the present subject matter.

Additionally or alternatively, gardening appliance 100 may include a display light 308. Display light 308 may be provided in third grow chamber 216. Third grow chamber 216 may be adjacent to front display opening 132 such that observers may view the contents of third grow chamber 216 through window 136. Accordingly, third grow chamber 216 may be in the display position. Display light 308 may be any suitable light, such as an LED, an incandescent bulb, a halogen bulb, or the like. Display light 308 may be operated according to a fixed schedule (e.g., a display schedule), or may be manually activated and deactivated to showcase the contents of third grow chamber 216 (or display position).

According to some embodiments, the third grow chamber 216 is a “resting chamber.” In this regard, third grow chamber 216 may not include any grow lighting other than natural lighting that enters through doors 134. Notably, by positioning all lighting assemblies 302 within first grow chamber 212 and second grow chamber 214, light emitted from lighting assemblies 302 may not escape cabinet through front display opening 132. Specifically, as described below, grow module 200 may substantially block the view of first grow chamber 212 and second grow chamber 214. Notably, as explained herein, this configuration may provide for optimal lighting requirements while minimizing light bleed, light pollution, and other harmful effects of light generated by lighting assemblies 302. It should be appreciated that exemplary embodiments of the present subject matter may include certain types of grow lighting within third grow chamber 216 aside from display light 308.

As explained above, light generated from lighting system 300 may result in light pollution within a room where gardening appliance 100 is located. Therefore, aspects of the present subject matter are directed to features for reducing light pollution, or to the blocking of light from light sources 324 through front display opening 132. Specifically, as illustrated, lighting system 300 may be positioned only within the enclosed back portion 130 of liner 120 such that only the first grow chamber 212 and second grow chamber 214 are exposed to light from light sources 324. Specifically, grow module 200 acts as a physical partition between light assemblies 300 and front display opening 132. In this manner, as illustrated in FIG. 5, no light may pass from first grow chamber 212 or second grow chamber 214 through grow module 200 and out through front display opening 132. As grow module 200 rotates, two of the three support sections 220-224 will receive light from lighting system 300 at a time. According to still other embodiments, a single light assembly may be used to reduce costs, whereby only a single grow chamber 210 will be lit at a single time.

As illustrated, each lighting assembly includes a plurality of elongated lighting boards, identified generally by reference numeral 310. As shown, the lighting boards are stacked adjacent each other and extend substantially along the axial direction A or the vertical direction V. Specifically, each lighting board 310 may be mounted directly to liner 120 that defines each respective grow chamber 212, 214. The elongated lighting boards 210 may extend parallel to each other and may be spaced apart from each other along the circumferential direction C. Notably, according to the illustrated embodiment, the spacing between elongated boards 210 may be selected such that lighting boards 310 are evenly spaced and cover an entire semicircular arc length of first grow chamber 212 and second grow chamber 214.

Moreover, elongated lighting boards 310 may be mounted to liner 120 such that they are oriented in a normal or perpendicular orientation relative to a surface of insulated liner 120. In this manner, the primary focus of light points inward along the radial direction R, e.g., directly toward grow module 200. In this manner, light generated by lighting assemblies 302 may be better directed toward plants 124 for a more distributed lighting configuration with better light dispersion and coverage.

Notably, lighting assemblies 302 may generate a considerable amount of heat during operation. As a result, it may be desirable that gardening appliance 100 include systems for cooling lighting system 300. Thus, gardening appliance 100 may include a fan assembly that is generally configured for directing a flow of cooling air over lighting assemblies 302 in order to maintain a suitably low operating temperature. In this regard, the fan assembly may include any suitable fan (e.g., such as axial fan), air blower, air handler, or other device for urging a flow of air over or near lighting assembly 302.

Light sources 324 may be provided as any suitable number, type, position, and configuration of electrical light source(s), using any suitable light technology and illuminating in any suitable color. For example, according to the illustrated embodiment, light source 324 includes one or more light emitting diodes (LEDs), which may each illuminate in a single color (e.g., white LEDs), or which may each illuminate in multiple colors (e.g., multi-color or RGB LEDs) depending on the control signal from controller 174. For example, according to an exemplary embodiment, first lighting assembly 304 and second lighting assembly 306 may include at least one of a white light emitting diode or a red light emitting diode. However, it should be appreciated that according to alternative embodiments, light sources 324 may include any other suitable traditional light bulbs or sources, such as halogen bulbs, fluorescent bulbs, incandescent bulbs, glow bars, a fiber light source, etc.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first support section and a second support section. According to such an embodiment, by rotating grow module 200 by 180 degrees about central axis 206, the first support section may alternate between the sealed position (e.g., facing rear side 114 of cabinet 102) and the display position (e.g., facing front side 112 of cabinet 102). By contrast, the same rotation will move the second support section from the display position to the sealed position. According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. According to still other embodiments, gardening appliance 100 may include a four or more chamber grow module 200, allowing for a wider variety of plant types to be grown. Thus, rotation schedules may vary to allow a variation of grow chambers to be displayed.

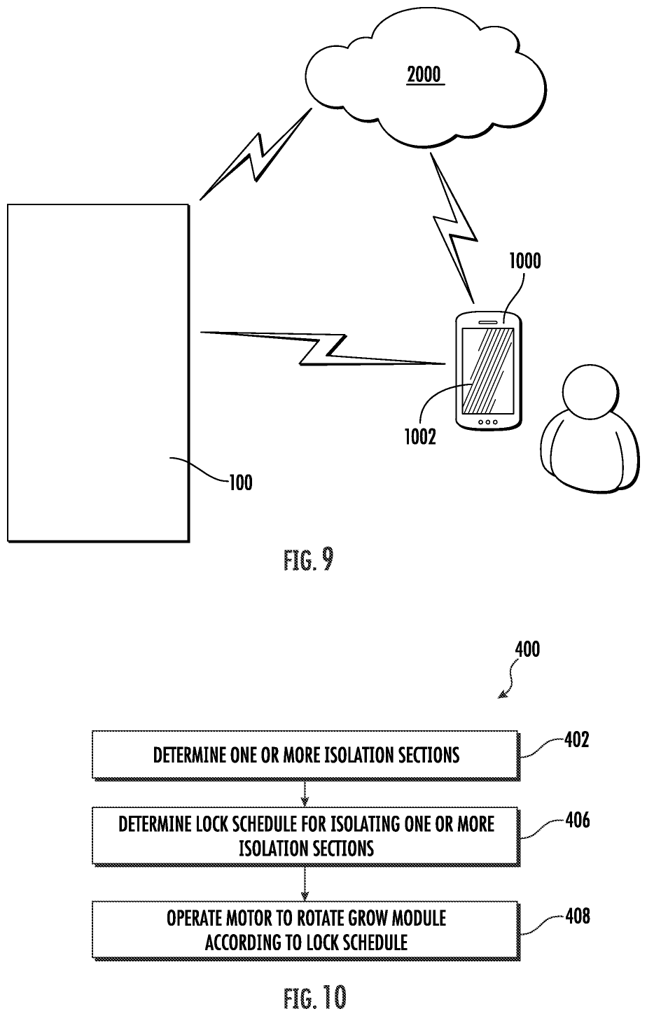

FIG. 9 schematically illustrates the gardening appliance 100 communicating with a remote user interface device 1000. Also shown (but not numbered) in FIG. 9 is a user such as may interact with the remote user interface device 1000, e.g., via a user interface 1002 of the remote user interface device 1000 such as a touchscreen in the illustrated embodiment. For example, the remote user interface device 1000 may be a hand-held device, such as a cell phone, smart phone, or any similar device, in operative communication with the controller 174 via a wireless connection. As shown in FIG. 9, the gardening appliance 100, and in particular, controller 174 thereof, may be configured to communicate with a separate device external to the appliance, such as a communications device or other remote user interface device 1000. The remote user interface device 1000 may be a laptop computer, smartphone, tablet, personal computer, wearable device, smart home system, and/or various other suitable devices. The gardening appliance 100 may include a network communication module, e.g., a wireless communication module, for communicating with the remote user interface device 1000. In various embodiments, a network communication module may include a network interface such that the controller 174 of the gardening appliance 100 can connect to and communicate over one or more networks with one or more network nodes. A network communication module may also include one or more transmitting, receiving, or transceiving components for transmitting/receiving communications with other devices communicatively coupled with gardening appliance 100. The network communication module may be in communication with, e.g., coupled or connected to, the controller 174 to transmit signals to and receive signals from the controller 174.

As schematically illustrated in FIG. 9, the gardening appliance 100 may be configured to communicate with the remote user interface device 1000 either directly or through a network 2000. Thus, in various embodiments, the gardening appliance 100 and the remote user interface device 1000 may be configured to communicate wirelessly with each other and/or with the network 2000. The network 2000 may be or include various possible communication connections and interfaces, e.g., such as Zigbee, BLUETOOTH®, WI-FI®, or any other suitable communication connection. The remote user interface device 1000 may include a memory for storing and retrieving programming instructions. For example, the remote user interface device 1000 may be a smartphone operable to store and run applications, also known as “apps,” and may include a remote user interface provided as a smartphone app.

Referring now to FIG. 10, a method 400 of operating a gardening appliance will be discussed. Method 400 may be applicable to any suitable gardening appliance (e.g., gardening appliance 100 described above). During certain growing operations, a user may wish to keep one or more support sections, or section chambers, isolated from a display opening (e.g., transparent window 136). Accordingly, a method of operating a gardening appliance in which one or more of the support sections remain in at least one of the sealed positions will be described herein.

At step 402, method 400 may include determining one or more isolation sections of a plurality of support sections. As discussed above, an exemplary gardening appliance may include several section chambers defined by a respective support section and a liner or display opening. As described above, the support sections may rotate as the grow module rotates, while the grow chambers are fixed positions (e.g., a sealed position or display position). Prior to operation, a user may wish to designate one or more support sections as isolation sections. In this respect, an “isolation” section refers to a support section that is contained in a sealed environment (i.e., one or more of the sealed positions described above). Further, the support sections designated as isolation sections may be prevented from cycling through the display position (i.e., adjacent to the display opening or transparent window). Thus, support sections designated as isolation sections may remain hidden from view and within a sealed environment.

A user may designate one or more isolation sections in a number of ways. In one example, the user presses a series of buttons (e.g., on a control panel such as control panel 170), in a predefined order to define the isolation section. The series of buttons may include a code, a pattern, multiple button presses at once, or the like. The gardening appliance may emit an alert notifying the user that an isolation section has been identified. The alert may include a sound, a message, a light flash, or the like.

In another example, the user designates one or more isolation sections via a remote device. The remote device may be one of a mobile telephone, a laptop, a tablet, a personal computer, or the like. The remote device may communicate with the gardening appliance via a wireless network, for instance. Accordingly, the user may select an individual support section to be an isolation section (e.g., through an application). Additionally or alternatively, the user may use the remote device to simply lock the grow module in place, effectively creating isolation sections out of the support sections which are currently not in the display position. The locked status of the grow module may remain in place for a predetermined period of time as designated by the user (e.g., via the application). Further, the user may select to end the locked status of the grow module via the remote device at any time. At this point, the gardening appliance may resume a regular rotation schedule.

At step 404, method 400 may include determining a lock schedule for isolating the one or more isolation sections among the plurality of support sections. In detail, the lock schedule may be different from the regular rotation schedule. For example, the regular rotation schedule may include step-rotating the grow module at equal time intervals in a single direction. Accordingly, each support section defined by the grow module cycles through each position (e.g., the first sealed position, the second sealed position, the display position, etc.). In one example, the time intervals are eight hours.

The lock schedule may incorporate various rotation motions of the grow module. The rotation of the grow module may be such that the one or more isolation sections remain in the one or more sealed positions. In other words, the one or more isolation sections may be restricted from entering the display position. As such, the one or more isolation sections may remain in a sealed environment. Advantageously, a delicate grow cycle requiring precision in terms of light exposure, moisture content, and air quality may be more effectively carried out.

At step 406, method 400 may include operating the motor to rotate the grow module in accordance with the lock pattern. The lock pattern may ensure that the one or more isolation sections are obscured from view through the display opening (or transparent window). For example, referring to gardening appliance 100 described above, the lock schedule includes rotating the grow module until the one or more designated isolation sections are in the one or more sealed positions. In detail, the controller may instruct the motor to rotate through a predetermined arc length (e.g., 120°). Accordingly, the one or more isolation sections may be located in a rear of the gardening appliance (i.e., away from the display position). For example, the display position and the sealed positions are indicated in FIG. 11. The one or more isolation sections may remain in the one or more sealed positions for a predetermined length of time (e.g., eight hours). This may be defined as a first cycle or first dwell time. After the predetermined period of time elapses, the lock schedule may rotate the grow module in a first direction. In detail, the controller may instruct the motor to rotate through the predetermined arc length. The first direction may be counterclockwise, although the disclosure is not limited in this regard. Referring again to FIG. 11, for example, the isolation section may be in a first sealed position at the outset of the lock schedule. Upon rotation, the isolation section may rotate from the first sealed position to a second sealed position.

In this regard, the second sealed position is still a sealed position (i.e., not exposed to the ambient and not in the display position). The isolation section may remain in the second sealed position for another predetermined amount of time (e.g., eight hours). This may be defined as a second cycle or second dwell time. In some embodiments, the first dwell time is the same as the second dwell time, however the disclosure is not limited to this. For example, the second dwell time may be longer than the first dwell time. At this point, the controller may rotate the grow module in a second direction. In detail, the controller may instruct the motor to rotate through the predetermined arc length in a different direction (e.g., to avoid positioning the isolation section in the display position). The second direction may be opposite to the first direction. For example, if the first direction is counterclockwise, the second direction is clockwise. Accordingly, the isolation section may rotate from the second sealed position back to the first sealed position. Thus, the isolation chamber remains in a sealed position, not exposed to ambient light or atmosphere, and not visible to observers. The grow module may remain in this position for another predetermined amount of time (e.g., eight hours). In some embodiments, the controller may instruct the motor to continue alternately rotating the grow module in the first and second directions a predetermined number of times (or cycles) according to specific grow schedules. Additionally or alternatively, the controller may instruct the motor to continue alternately rotating the grow module in the first and second directions until a user turns off the lock schedule. In some embodiments, the lock schedule may be run over a predetermined set of hours (i.e., during daytime hours, etc.).

The lock schedule may include a lighting schedule. For example, the gardening appliance may include a first lighting assembly and a second lighting assembly (e.g., as described above with respect to gardening appliance 100). The first lighting assembly may be provided in the first sealed position. The second lighting assembly may be provided in the second sealed position. The first lighting assembly and the second lighting assembly may be operated independently from each other. In other words, the first lighting assembly may be turned on and off independently from the second lighting assembly. During the first dwell time, for example, each of the first lighting assembly and the second lighting assembly may be activated. Accordingly, each of the first sealed position and the second sealed position may be provided with light (e.g., grow light). Moreover, during the second dwell time, the first lighting assembly may be activated, and the second lighting assembly may be deactivated. Accordingly, the first sealed position may be provided with light (e.g., grow light) while the second sealed position may not be provided with light. Further, since the second sealed position is not exposed to ambient conditions, no light may be provided to the second sealed position. It should be understood that any suitable combination of activation and deactivation of the first and second lighting assemblies may be incorporated according to specific grow schedules.

Additionally or alternatively, the display position may include a display light (e.g., display light 308 in FIG. 2). The display light may provide light to the display position (e.g., during night time or presentation times). The display light may be activated according to specific schedules in addition to the first and second lighting assemblies. For instance, the display light may be activated during the second cycle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a gardening appliance, the gardening appliance comprising a cabinet including a display opening, a grow module rotatably mounted within the cabinet and defining a plurality of support sections, and a motor configured to rotate the grow module, the method comprising:
determining one or more isolation sections of the plurality of support sections;
determining a lock schedule for isolating the one or more isolation sections among the plurality of support sections; and
operating the motor to rotate the grow module in accordance with the lock schedule such that the one or more isolation sections are obscured from view through the display opening.

2. The method of claim 1, further comprising:
obtaining a regular rotation schedule to rotate the grow module via the motor, wherein the regular rotation schedule is different from the lock schedule.

3. The method of claim 2, wherein the lock schedule comprises:
rotating the grow module in a first direction over a predetermined arc length;
pausing the rotation for a first dwell time after rotating the grow module in the first direction;
rotating the grow module in a second direction opposite from the first direction over the predetermined arc length after the first dwell time; and
pausing the rotation for a second dwell time after rotating the grow module in the second direction.

4. The method of claim 3, wherein the plurality of support sections comprises three support sections and the arc length is 120°.

5. The method of claim 4, wherein the cabinet and the grow module collectively define a first sealed position, a second sealed position, and a display position, and wherein the method further comprises:
alternating a location of the one or more isolation sections between the first sealed position and the second sealed position.

6. The method of claim 5, wherein the lock schedule permits all other support sections among the plurality of support sections aside from the one or more isolation sections to cycle through the display position.

7. The method of claim 6, wherein the first sealed position comprises a first lighting assembly and the second sealed position comprises a second lighting assembly, the method further comprising:
operating the first lighting assembly and the second lighting assembly independently from each other.

8. The method of claim 7, wherein the first sealed position and the second sealed position are not exposed to ambient light.

9. The method of claim 8, further comprising:
activating the first lighting assembly and the second lighting assembly during the first dwell time; and
activating the first lighting assembly and deactivating the second lighting assembly during the second dwell time.

10. The method of claim 5, wherein the gardening appliance further comprises a display light provided in the display position, and wherein the method further comprises:
activating the display light during the second dwell time.

11. The method of claim 10, wherein determining the lock schedule comprises selecting one of a first support section, a second support section, and a third support section to be obscured from view through the display opening for at least a predetermined period of time.

12. The method of claim 1, wherein the lock schedule is selected via a remote device.

13. The method of claim 1, wherein the plurality of support sections comprises at least four support sections.

14. The method of claim 13, wherein the one or more isolation sections comprises two isolation sections.

15. A gardening appliance, comprising:
a liner positioned within a cabinet and defining a grow chamber;
a display opening provided in the cabinet;
a grow module rotatably mounted within the liner, the grow module defining a plurality of support sections;
a motor provided within the cabinet and configured to rotate the grow module; and
a controller operably coupled to the motor and configured to perform a series of operations, the series of operations including:
determining one or more isolation sections of the plurality of support sections;
determining a lock schedule for isolating the one or more isolation sections among the plurality of support sections; and
operating the motor to rotate the grow module in accordance with the lock schedule such that the one or more isolation sections are obscured from view through the display opening.

16. The gardening appliance of claim 15, wherein the lock schedule comprises:
rotating the grow module in a first direction over a predetermined arc length;
pausing the rotation for a first dwell time after rotating the grow module in the first direction;
rotating the grow module in a second direction opposite from the first direction over the predetermined arc length after the first dwell time; and
pausing the rotation for a second dwell time after rotating the grow module in the second direction.

17. The gardening appliance of claim 16, wherein the plurality of support sections comprises three support sections and the arc length is 120°.

18. The gardening appliance of claim 17, wherein the cabinet and the grow module collectively define a first sealed position, a second sealed position, and a display position, and wherein the series of operations further comprises alternating a location of the one or more isolation sections between the first sealed position and the second sealed position.

19. The gardening appliance of claim 18, wherein the first sealed position comprises a first lighting assembly, and the second sealed position comprises a second lighting assembly, and wherein the first lighting assembly and the second lighting assembly are operated independently from each other.

20. The gardening appliance of claim 19, wherein the series of operations further comprises:
activating the first lighting assembly and the second lighting assembly during the first dwell time; and
activating the first lighting assembly and deactivating the second lighting assembly during the second dwell time.
